(19) United States
(12) Patent Application Publication
(10) Pub. No.: US 2012/0037773 A1
(43) Pub. Date: Feb. 16, 2012

(54) HANGING STRUCTURE OF HI-FI SET OF ELECTRONIC WHITEBOARD

(76) Inventors: Yueh-Hua HSU HUANG, Chung-Ho City (TW); Lien-Huang Yang, Chung-Ho City (TW)

(21) Appl. No.: 12/877,283

(22) Filed: Sep. 8, 2010

(30) Foreign Application Priority Data
Aug. 10, 2010 (TW) 099215249

(51) Int. Cl. F16B 13/02

(52) U.S. Cl. 248/224.8

(57) ABSTRACT

A hanging structure of a hi-fi set of an electronic whiteboard comprises: a locking area, which is at one side of the hanging structure and has a plurality of locking holes for fixing the hanging structure on the electronic whiteboard; and a snapping area, which is at another side of the hanging structure, the thickness of the snapping area is thinner than the thickness of the locking area in order to form a space, wherein the hi-fi set has a plurality of hooking members, each hooking member is through the hanging hole of the to snapping area and downwardly snapping at the snapping area, further, the hanging structure can independently make the hi-fi set be hanged on a wall surface.

### BACKGROUND OF THE INVENTION

1. Field of the Invention

The present invention generally relates to a hanging structure of a hi-fi set of an electronic whiteboard, more particularly to a hanging structure that makes the hi-fi set be hanged on the two sides of the electronic whiteboard or a wall surface.

2. Description of the Prior Art

With the advance of digital technologies, a digital presentation device gradually replaces traditional projection devices. Such digital presentation device is an electronic whiteboard in the present market. Everything shown on the electronic whiteboard can be presented by computer, and the whiteboard is rewriteable, hence it is able to replace a single projector and even a general black/white board in classroom.

For a business aspect of electronic whiteboard technology, the electronic whiteboard is connected with computer, projector or hi-fi set via some special interfaces. It is not only an output role for computer, but also an input media. The writable area of the electronic whiteboard can be a presentation area. An added hi-fi set may increase multiple functions as outputting sound, so that an interactive electronic whiteboard is provided.

With reference to FIG. 1A, which illustrates a schematic exploded view of a traditional electronic whiteboard combined with a hi-fi set, wherein a trapezoid iron piece 11 and a rectangle structure 12 with a sunken space 121 are fixed to an electronic whiteboard 2, the trapezoid iron piece 11 is fastened to the rectangle structure 12 via a plurality of bolts 41 and nuts 42, the bottom of the sunken space 121 has three droplet-type holes 1211, thus three fixing members 31 with three scrobicular rings 311 on the hi-fi set 3 penetrate through the three droplet-type holes 1211, and the scrobicular rings 311 of the fixing members 31 downwardly snap at the bottoms of the droplet-type holes 1211, so that the hi-fi set 3 is hanged on the two sides of the electronic whiteboard 2 via the rectangle structure 12, please refer to FIG. 1B.

With references to FIG. 2A and FIG. 2B, the sunken space 121 of the rectangle structure 12 can face to a wall surface 5, then the rectangle structure 12 can be fastened to the wall surface 5 by means of screwing bolts 41 in the wall surface 5, then the fixing members 31 with scrobicular rings 311 of the hi-fi set 3 can go through the droplet-type holes 1211, and the scrobicular rings 311 of the fixing members 31 downwardly snap at the bottoms of the droplet-type holes 1211, so that the hi-fi set 3 is hanged on the wall surface 5 via the rectangle structure 12.

The assembled structures of the connecting components of above electronic whiteboard 2 and hi-fi set 3 are complicate, hence the inconveniences may happen while installing and dismantling. Further, the smaller portion of each droplet-type hole 1211 shall be laid out downwardly in order to make the hi-fi set 3 be hanged on the rectangle structure 12, and the shape of the droplet-type hole 1211 is designed for the heavier hi-fi set 3. Unfortunately the whole structure is complicate and must be two members, it causes higher cost.

Hence, to develop a single hanging structure for the hi-fi set of the electronic whiteboard that makes the hi-fi set be hanged on the electronic whiteboard or the wall surface and the hanging structure being applied to different hi-fi sets are the most important issues for the skilled persons in the art.

### SUMMARY OF THE INVENTION

The main objective of the present invention is to provide a hanging structure of a hi-fi set of an electronic whiteboard, which is a simple connecting structure in order to easily hang the hi-fi set on the two sides of the electronic whiteboard or an independent wall surface.

The second objective of the present invention is to provide the hanging structure of the hi-fi set of the electronic whiteboard, which is applied to different types of hi-fi sets and tremendously decrease the difficulties of installment and dismantling in order to lower the cost.

To reach above objectives, one side of the hanging structure is a locking area that has a plurality of locking holes in order to fix the hanging structure on the two sides of the electronic whiteboard, another side of the hanging structure is a snapping area, the thickness of the snapping area is thinner than the thickness of the locking area in order to form a space between the locking area and the snapping area, the space is to combine with the hi-fi set, the snapping area having a plurality of hanging holes, the hi-fi set has a plurality of hooking members, each hooking member is through the hanging hole of the snapping area and downwardly snaps at the snapping area, the space faces to the wall surface so as to fasten the hanging structure on the wall surface, the hi-fi set is thus snapped at the snapping area of the hanging structure, so the hi-fi to set is hanged on the wall surface.

Other and further features, advantages, and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits, and advantages of the preferred embodiments of the present invention will be readily understood by the accompanying drawings and detailed descriptions, wherein:

FIG. 1A illustrates a schematic exploded view of a traditional electronic whiteboard combined with a hi-fi set;

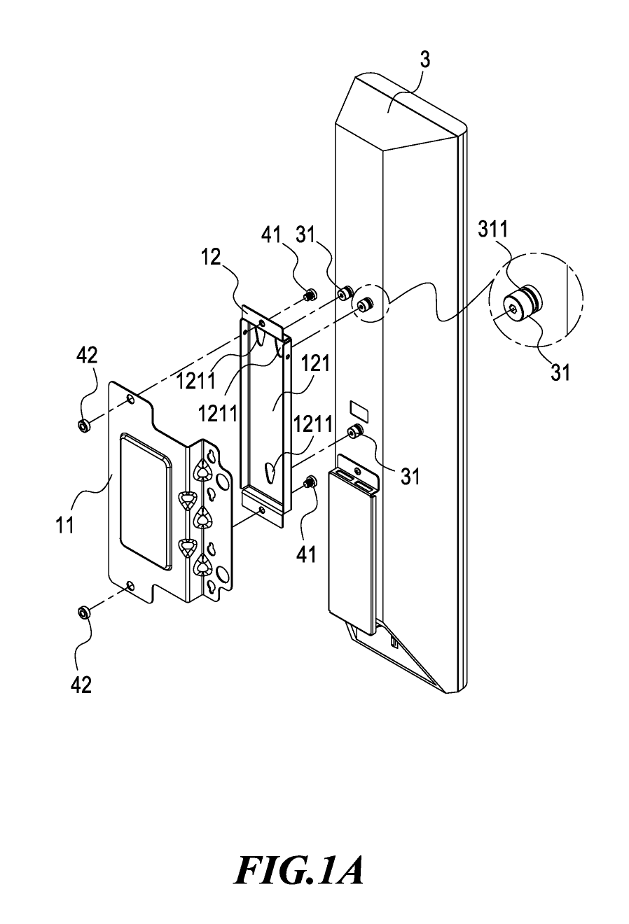

FIG. 1B illustrates a schematic assembled view of the traditional electronic whiteboard combined with the hi-fi set;

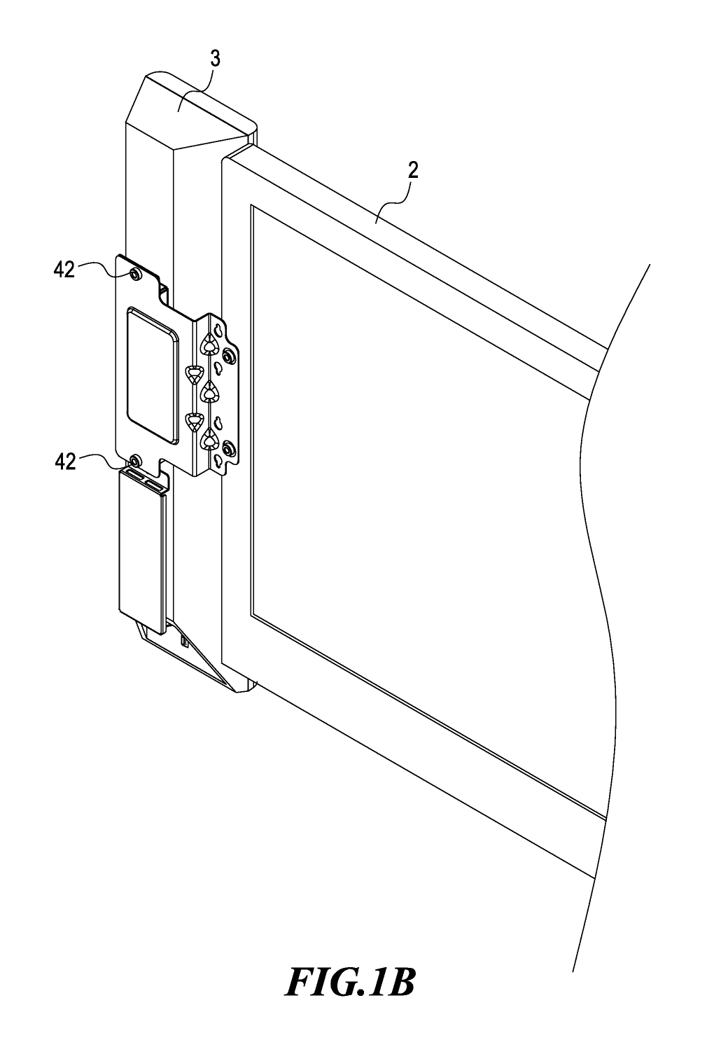

FIG. 2A illustrates another schematic exploded view of the traditional electronic whiteboard combined with the hi-fi set;

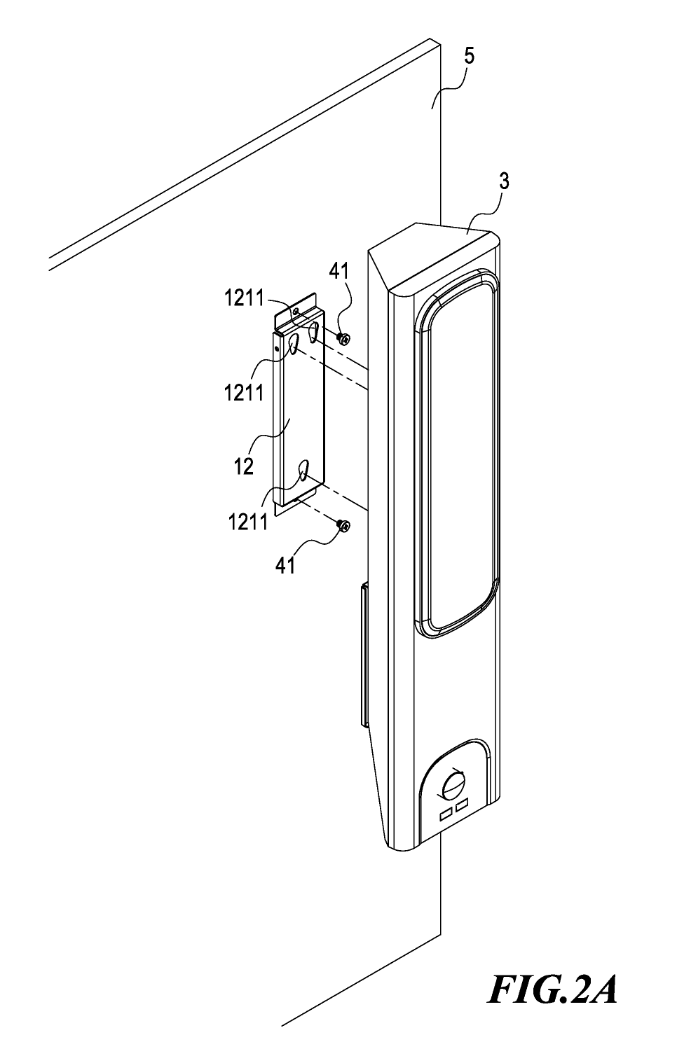

FIG. 2B illustrates another schematic assembled view of the traditional electronic whiteboard combined with the hi-fi set;

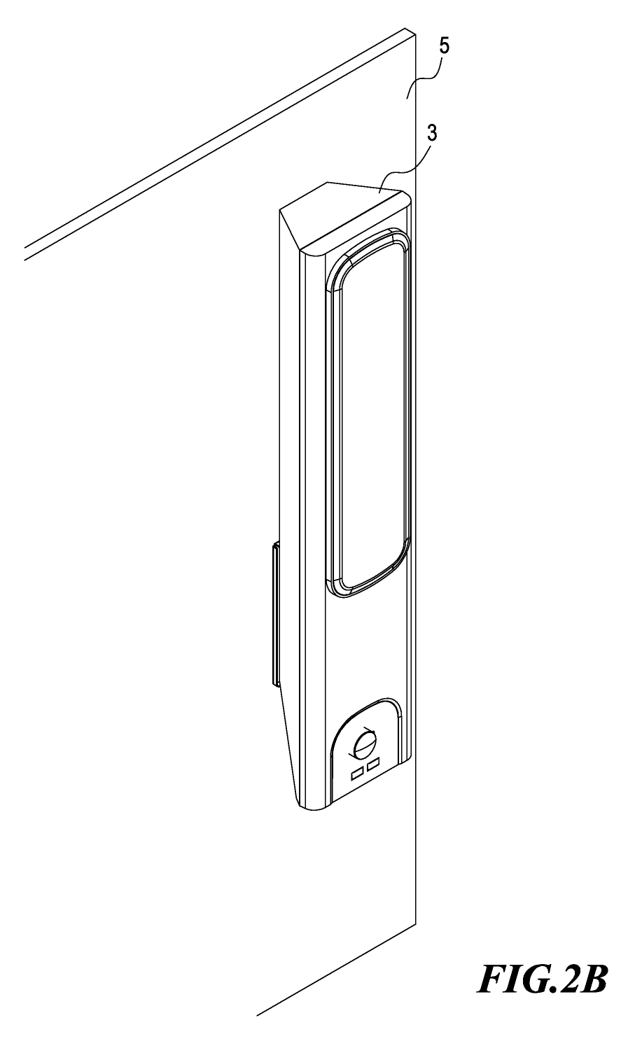

FIG. 3 illustrates a whole schematic view of a hanging structure of a hi-fi set of an electronic whiteboard of the present invention;

FIG. 4A illustrates a schematic exploded view of a first preferred embodiment of the hanging structure of the hi-fi set of the electronic whiteboard of the present invention;

FIG. 4B illustrates a partial schematic exploded view of the first preferred embodiment of the hanging structure of the hi-fi set of the electronic whiteboard of the present invention;

FIG. 4C illustrates a schematic assembled view of the first preferred embodiment of the hanging structure of the hi-fi set of the electronic whiteboard of the present invention;

FIG. 5A illustrates a schematic exploded view of a second preferred embodiment of the hanging structure of the hi-fi set of the electronic whiteboard of the present invention; and

FIG. 5B illustrates a schematic assembled view of the second preferred embodiment of the hanging structure of the hi-fi set of the electronic whiteboard of the present invention.

### DETAILED DESCRIPTION OF THE INVENTION

Following preferred embodiments and figures will be described in detail so as to achieve aforesaid objects.

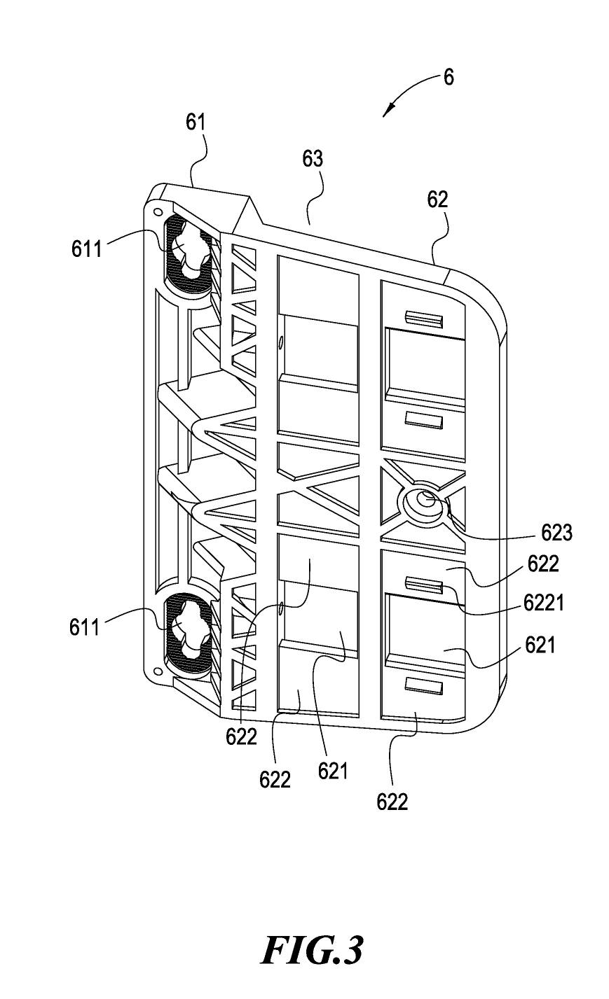

With reference to FIG. 3, which illustrates a whole schematic view of a hanging structure of a hi-fi set of an electronic whiteboard of the present invention. As shown in the figure, one side of the hanging structure 6 is a locking area 61 that has a plurality of locking holes 611, another side of the hanging structure 6 is a snapping area 62, the thickness of the snapping area 62 is thinner than the thickness of the locking area 61 in order to form a space 63 between the locking area 61 and the snapping area 62, the space 63 is to combine the hi-fi set.

Preferably, the snapping area 62 has a plurality of hanging holes 621, each side of the hanging hole 621 has a snapping plate 622 with a protruding block 6221.

Preferably, the snapping area 62 comprises at least one threading hole 623.

Preferably, the hanging hole 621 is a square through hole.

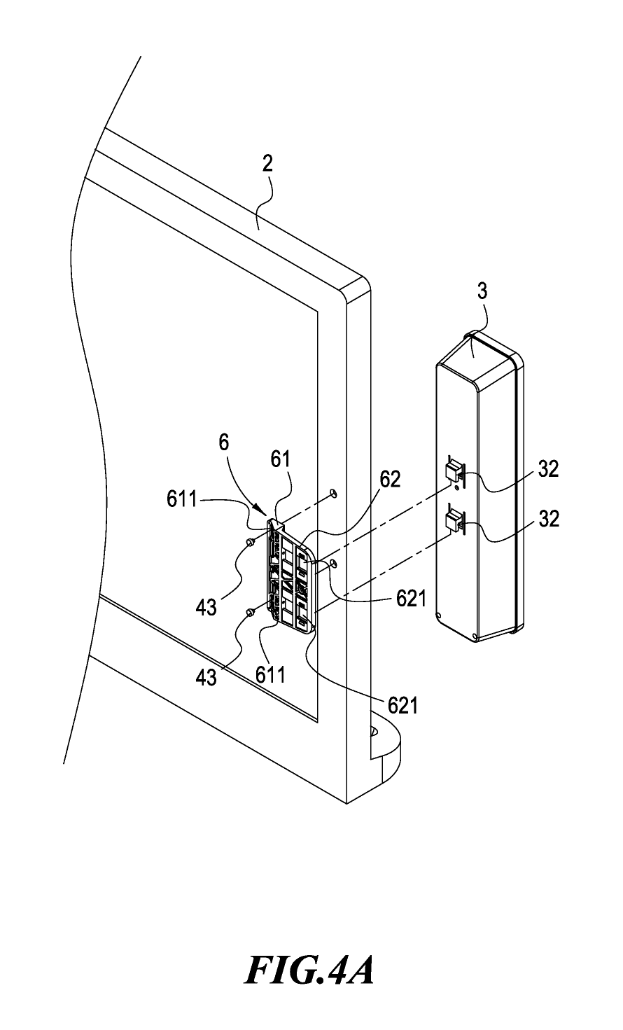

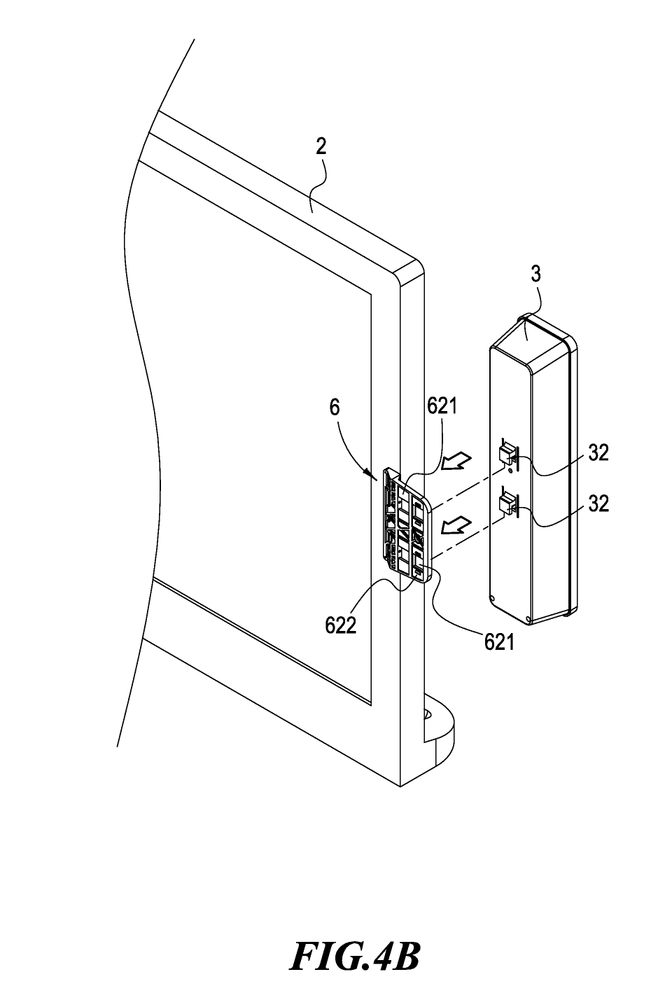

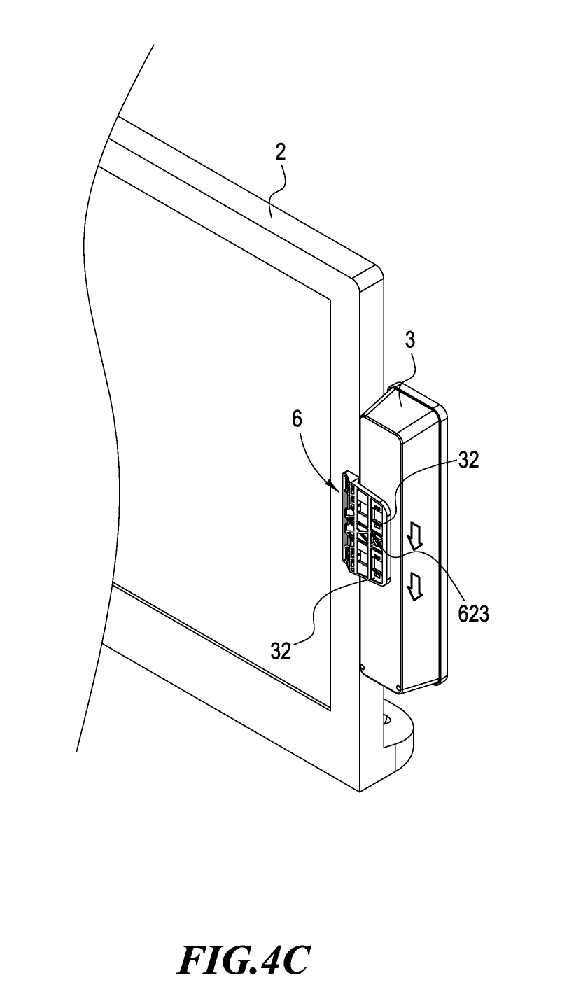

With references to FIG. 3, FIG. 4A, FIG. 4B, and FIG. 4C, the hanging structure 6 is fixed on the electronic whiteboard 2 by means of using a plurality of locking components 43 to penetrate through the cross locking holes 611, so that the hi-fi set 3 is able to be hanged on two sides of the electronic whiteboard 2 via the hanging structure 6, the hi-fi set 3 has a plurality of hooking members 32, each hooking member 32 is through the hanging hole 621 of the snapping area 62 and downwardly snapping at the snapping plate 622 of the snapping area 62, the protruding block 6221 on each snapping plate 622 is to enhance the stability of hanging the hi-fi set 3 on the hanging structure 6.

Preferably, the threading hole 623 of the snapping area 62 is for connecting lines of the hi-fi set 3 or a power line going through, so that the electronic whiteboard 2 or the hi-fi set 3 can be electronically connected with.

Preferably, the locking hole 611 of the locking area 61 is a cross through hole with threads thereon, so that the locking component 43 can be focused on the center of the cross through hole and then penetrate through the locking hole 611 for locking the hanging structure 6 onto the electronic whiteboard 2.

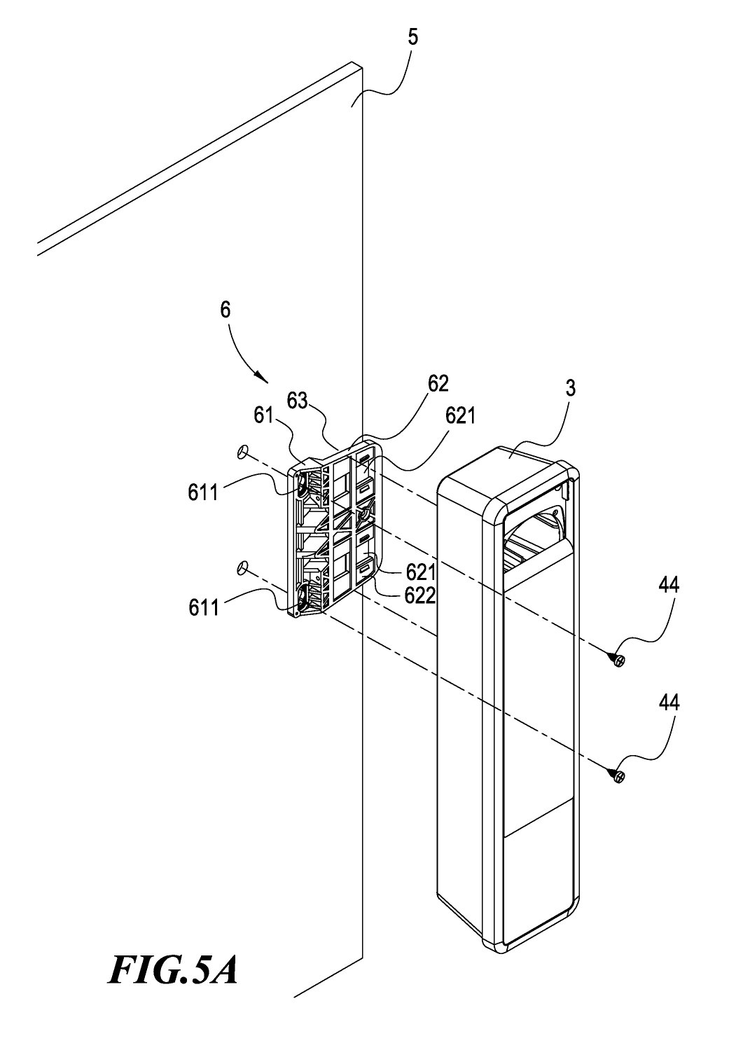

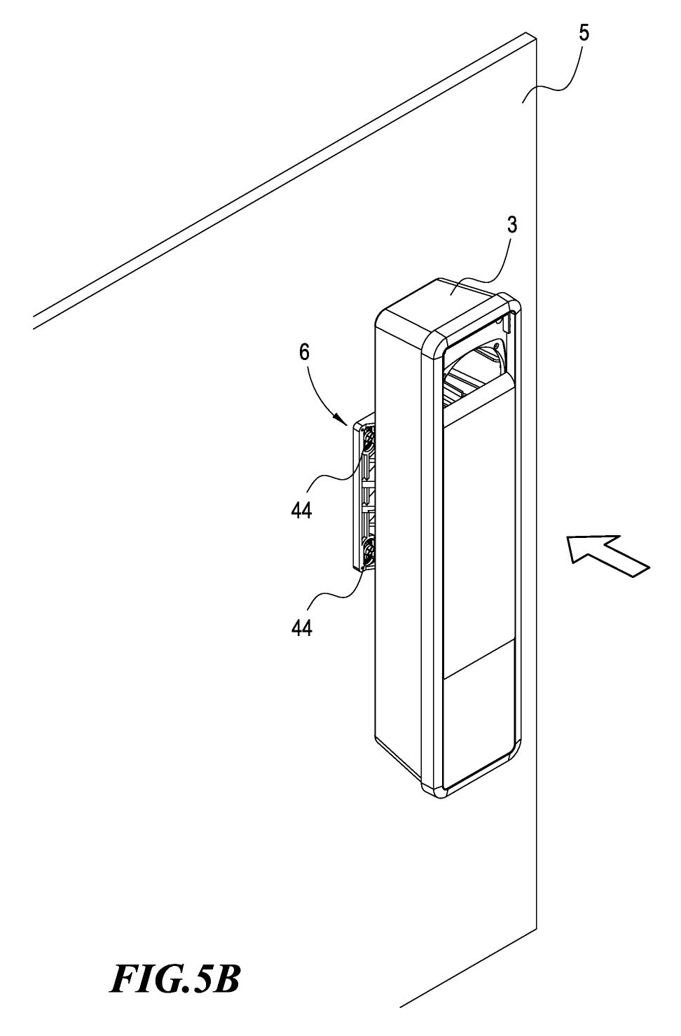

With references to FIG. 3, FIG. 5A and FIG. 5B, the hanging structure 6 can also be a role that makes the hi-fi set 3 to be hanged on a wall surface 5, wherein the hanging structure 6 is fixed on a wall surface 5 by means of using a plurality of locking components 44 to penetrate through the cross locking holes 611 of the hanging structure 6, so that the hi-fi set 3 is able to be hanged on the wall surface 5 via the hanging structure 6 and the space 63 faces to the wall surface 5, the hi-fi set 3 has a plurality of hooking members 32, each hooking member 32 is through the hanging hole 621 of the snapping area 62 and downwardly snapping at the snapping plate 622 of the snapping area 62, the protruding block 6221 on each snapping plate 622 is to enhance the stability of hanging the hi-fi set 3 on the hanging structure 6.

Preferably, the locking hole 611 of the locking area 61 is a cross through hole with threads thereon, so that the locking component 44 can be focused on the center of the cross through hole and then penetrate through the locking hole 611 via drilling a through hole on the wall surface 5 for locking the hanging structure 6 onto the wall surface 5, then, the hanging structure 6 is to hang the hi-fi set 3 on the wall surface 5.

Preferably, the threading hole 623 of the snapping area 62 is for connecting lines of the hi-fi set 3 or a power line going through.

With the comparisons to other hanging structures of electronic whiteboards, the advantages of the present invention are listed below:
1. The present invention provides a simple hi-fi set connecting structure for the electronic whiteboard, that is, the hi-fi set is easily hanged on the two sides of the electronic whiteboard or the wall surface.
2. The present invention can be applied to different types of hi-fi sets and tremendously decrease the difficulties of installment and dismantling in order to lower the cost.

Although the invention has been disclosed and illustrated with reference to particular embodiments, the principles involved are susceptible for use in numerous other embodiments that will be apparent to persons skilled in the art. This invention is, therefore, to be limited only as indicated by the scope of the appended claims

What is claimed is:

1. A hanging structure of a hi-fi set of an electronic whiteboard comprising:
a locking area, being at one side of the hanging structure and having a plurality of locking holes; and
a snapping area, being at another side of the hanging structure, the thickness of the snapping area being thinner than the thickness of the locking area in order to form a space, the snapping area having a plurality of hanging holes.

2. The hanging structure of the hi-fi set of the electronic whiteboard according to claim 1, wherein the locking hole is a cross through hole.

3. The hanging structure of the hi-fi set of the electronic whiteboard according to claim 1, wherein each side of the hanging hole has a snapping plate with a protruding block.

4. The hanging structure of the hi-fi set of the electronic whiteboard according to claim 1, wherein the snapping area comprises at least one threading hole, which is for connecting lines of the hi-fi set or a power line going through.

5. The hanging structure of the hi-fi set of the electronic whiteboard according to claim 1, wherein the hanging hole is a square through hole.

6. The hanging structure of the hi-fi set of the electronic whiteboard according to claim 2, wherein the hanging structure is fixed on the electronic whiteboard by means of using a plurality of locking components to penetrate through the cross locking holes, so that the hi-fi set is able to be hanged on two sides of the electronic whiteboard via the hanging structure.

7. The hanging structure of the hi-fi set of the electronic whiteboard according to claim 6, wherein the hi-fi set has a plurality of hooking members, each hooking member being through the hanging hole of the snapping area and downwardly snapping at the snapping area.

8. The hanging structure of the hi-fi set of the electronic whiteboard according to claim 2, wherein the hanging structure is fixed on a wall surface by means of using a plurality of locking components to penetrate through the cross locking holes of the hanging structure, so that the hi-fi set is able to be hanged on the wall surface via the hanging structure and the space faces to the wall surface.

9. The hanging structure of the hi-fi set of the electronic whiteboard according to claim 8, wherein the hi-fi set has a plurality of hooking members, each hooking member being through the hanging hole of the snapping area and downwardly snapping at the snapping area.
